(19) United States
(12) Patent Application Publication
(10) Pub. No.: US 2019/0086918 A1
(43) Pub. Date: Mar. 21, 2019

(54) ROAD USER, TRAFFIC SYSTEM AND METHOD

(71) Applicant: OSRAM GmbH, Munich (DE)

(72) Inventors: Guido Angenendt, Munich (DE); Norbert Haas, Langenau (DE)

(21) Appl. No.: 16/132,535

(22) Filed: Sep. 17, 2018

(30) Foreign Application Priority Data
Sep. 18, 2017 (DE) 10 2017 216 507.3

(51) Int. Cl. G05D 1/00; G07C 5/00

(52) U.S. Cl. CPC G05D 1/0061; G05D 2201/0213; G07C 5/008; G05D 1/0088

(57) ABSTRACT

A road user includes a sensor with which information is acquirable for the road user from its environment, a communication circuit by means of which the information is at least one of transmittable or receivable, and a controller which has a processor by means of which the information can be evaluated, and a control apparatus by means of which the road user is fully or partially autonomously controllable depending on the information at least one of acquired by the sensor or received by the communication circuit. A control of the road user by its controller is transferable to a central controller on the basis of at least one previously defined criterion.

### CROSS-REFERENCE TO RELATED APPLICATION

This application claims priority to German Patent Application Serial No. 10 2017 216 507.3, which was filed Sep. 18, 2017, and is incorporated herein by reference in its entirety.

### TECHNICAL FIELD

Various embodiments relate generally to a road user, a traffic system and a method.

### BACKGROUND

Partially autonomous and autonomous vehicles which have sensor technology and a control unit are known. The term sensor technology includes not only one or more transmitting devices, for example RADAR or LIDAR, but also one or more sensor systems for picking up the transmit signals reflected onto the sensors, for example reflection from RADAR and LIDAR measurement signals, and/or for picking up externally provided signals. The term sensor system, sensor unit and sensor apparatus are also used here as an alternative to the term sensor technology. Here, an autonomous vehicle is controllable by the control unit independently from a person. A partially autonomous vehicle may be a vehicle which cannot act completely autonomously and requires monitoring by a driver. Autonomous or partially autonomous vehicles at levels 0 to 4 require an intervention on the part of a driver, at least in specific situations. Autonomous vehicles at level 5 can be controlled totally independently from the driver. Autonomous vehicles have a multiplicity of sensors for acquiring, in particular, information from the environment and information relating to the driving status. The position of the autonomous vehicle, for example, is measured with centimeter precision and its movement trajectory is also determined. A road layout, an object distance, a speed, an acceleration, and movement trajectories of other road users can furthermore be determined. Traffic regulations, parking regulations, speed restrictions, possible hazardous areas, obstacles or roadworks, information relating to the road condition and traffic and weather conditions and to environmental pollution can furthermore be acquired. Some of the information, such as, for example, information relating to traffic and weather conditions, and also relating to air quality or the road condition, can be provided from external sources. A large number of sensor technology systems and high-speed data transmission which advantageously meets cyber security requirements are required so that the autonomous vehicle or the control unit of the autonomous vehicle can acquire this multiplicity of information elements. Substantial processing power is furthermore required in order to evaluate the information. The evaluation of the information furthermore requires a complex evaluation algorithm.

If partially autonomous or autonomous vehicles exclusively or primarily use their own sensors or sensor technology systems, this has the disadvantage that an environment is detected to a very limited extent only. A tailback, for example, is then detected too late or an unsuitable detour around the tailback is provided. It may thus, for example, be that all partially autonomous or autonomous vehicles disadvantageously follow the same diversion in the event of a tailback. It may thus be disadvantageous if autonomous vehicles individually evaluate and interpret acquired and/or transmitted information and control the vehicle depending thereon.

As already mentioned above, an autonomous vehicle tends to detect only the immediate environment. It can be provided that adjacent vehicles or an adjacent infrastructure transmit information and data to the autonomous vehicle, with which the latter's information radius can be extended, but information relating to greater distances is also lacking here. It is furthermore disadvantageous that a data volume which can be transferred, for example, from an external source (“cloud”) to the autonomous vehicle for the provision of information is limited. The data volume which the control unit of an autonomous vehicle can process for control purposes within the shortest times is furthermore limited.

### SUMMARY

A road user includes a sensor with which information is acquirable for the road user from its environment, a communication circuit by means of which the information is at least one of transmittable or receivable, and a controller which has a processor by means of which the information can be evaluated, and a control apparatus by means of which the road user is fully or partially autonomously controllable depending on the information at least one of acquired by the sensor or received by the communication circuit. A control of the road user by its controller is transferable to a central controller on the basis of at least one previously defined criterion.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a system with a road user and with a central control unit in a schematic representation;

FIG. 2 shows a system with a first central control unit and a further central control unit and a road user in a schematic representation; and

FIG. 3 shows schematically a method with the system and the road user.

### DESCRIPTION

The following detailed description refers to the accompanying drawings that show, by way of illustration, specific details and embodiments in which the invention may be practiced.

Various embodiments provide a road user, a traffic system and a method with which road safety can be increased and traffic flow can be improved and/or speeded up.

According to various embodiments, a road user is provided which may be designed as a fully or partially autonomous vehicle. The road user may have a sensor unit with which information, for example from its environment, is acquirable. The road user may furthermore have a communication unit by means of which it can transmit and/or receive information. The road user may additionally have a controller, e.g. a control unit. The control unit may have a processing unit and/or a control apparatus by means of which the road user is controllable. The processing unit can process information. By means of its communication unit which has a transmitting device and a receiving device, the road user can additionally receive information, for example from external, for example stationary, sensor apparatuses and/or from sensor units of other road users and/or can communicate with the latter. The road user may be completely or partially autonomously movable by means of its control unit, depending on the information from its own sensor unit and/or the information which is receivable by the communication unit. It is possible for a control of the road user to be transferable from its control unit to a central or external control unit according to at least one specific criterion.

This solution offers the effect that the road user is controllable by the central control unit. As a result, a multiplicity of information elements which are available to the control unit can be used to determine an optimum traffic route and/or an optimum driving behavior for the road user by means of the central control unit. The controller, e.g. the control unit of the road user may decide whether a takeover of the control by the central control unit should be accepted, for example due to increased traffic volume.

Additionally or alternatively, the information from the external control unit can thereby be available to the processing unit of the road user in addition to the information which the sensor unit of the road user acquires. This information which the sensor unit of the road user has not acquired can then be incorporated into the control of the road user. As a result, road safety can be increased. A risk due to rear-end collisions, for example, can be reduced, since information relating to the accident is already incorporated into the control of the road user even though the sensor unit of said road user has not yet detected the accident.

Information can be exchanged between the central control unit and the control unit of the road user via a wireless system, such as, for example, electromagnetic waves, for example Bluetooth and/or mobile radiocommunication, such as, for example, the Long Term Evolution (LTE) standards for 3G and 4G, or 5G) and/or light waves (Visible Light Communication). Fast and uncomplicated communication between the external control unit and the control unit of the road user can be achieved as a result. The data can be exchanged in encrypted form.

A traffic system for a locally limited traffic area is furthermore provided according to various embodiments. The traffic system may have at least one higher-level, e.g. central, control unit. The central control unit can be connected to or can have a communication device and/or a processing unit and/or a sensor unit. The central control unit can communicate by means of the communication device with the communication device of at least one or more road users which are located, for example, on the traffic area controlled by it. A locally limited traffic area may, for example, be a suburban area, a Park & Ride parking lot, a feeder road, an urban area, a conservation area, a freeway interchange, a speed-sensitive area, a hazardous goods area, a flood zone or a disaster area. A locally limited traffic area may additionally be subject to a time regulation and/or restriction, so that it is monitored by a central control unit, for example, only at specific times of the day and night or only on specific days, for example public holidays and/or holiday periods.

The central control unit can be configured in such a way that autonomous and/or partially autonomous road users are fully or partially controllable by it on the traffic area. To do this, the central control unit can access the respective individual control unit of the road user and therefore the control of the road user. The connection may be set up wirelessly via the communication device of the central control unit and the communication device of the at least one road user, as explained above.

Prior to a takeover of the control of the road user, the external control unit can identify itself to the control unit of said road user. This identification may be performed by means of a certificate, e.g. an authentication certificate. The identification can take place, for example, if the road user is detected by the central control unit, for example because it comes within range. The detection is possible, for example, by means of a Global Positioning System (GPS). As a result, safety risks through misuse of the technology can be minimized. The data communication can also be implemented in encrypted form.

It is also possible for the central control unit to output regularly a signal with which, for example, the option of a takeover of control is offered to all road users within range.

Furthermore, the at least one road user can advantageously be informed by the central control unit of the traffic areas or areas on which an external control by the central control unit is possible. The road user can then connect to the central control unit by means of its communication unit and transfer its control to said central control unit.

If control is taken over by the central control unit, the road user can inform said control unit of the destination of the journey. The central control unit can then calculate the optimum route and/or the optimum driving behavior on the traffic area monitored by it, taking account of the totality of the information. This driving behavior can be based on specifications which can be stored in the road user, for example the fastest route or shortest route or most fuel-efficient driving style.

The local control unit of the road user can be taken over by the central control unit according to specific, e.g. predefined, criteria. The at least one criterion may, for example, be preset in the control unit. They may be set, for example, ex-works in the control unit of a road user or vehicle and/or may be settable, for example, by a workshop.

It is furthermore possible for the at least one criterion to be definable by a person, for example a driver and/or passenger of a vehicle, before the start of a journey. The at least one criterion may also be a release by a person, for example in the vehicle, during a journey.

In other words, it is possible for the control unit of the road user or, in the case of a partially autonomous road user, a person to decide whether the central control unit is to take over the control of the road user. If the decision is made by a person, said person can be asked, for example via a screen, for example on a dashboard, or audibly, whether a release is to be granted. The person can then accept or reject a takeover of the control. If the takeover of the control of the road user by the central control unit is rejected, said road user can continue to move partially or fully autonomously. However, it can additionally be supplied by the central control unit with information extending beyond the information which it has acquired with its sensor unit.

The at least one criterion may, for example, be a simple entry by the road user into an area controllable by the central control unit. Furthermore, the at least one criterion may, for example, be a tailback warning and/or a high traffic volume, for example due to an accident and/or roadworks on the traffic area.

A totality of all information on the traffic area can advantageously be gathered and evaluated by the central control unit. As a result, an optimum control and monitoring of all road users on the traffic area can simultaneously be enabled, depending on all available information. The totality of the information on the traffic area can additionally be provided by the central control unit to all road users located on the traffic area. Road safety can therefore be increased. For example, accidents can be avoided.

Rear-end collisions, for example, can be prevented, since the information relating to the accident can be forwarded to a road user before the accident can be detected by the sensor unit of the road user. A traffic tailback due to roadworks, for example, and/or high traffic volume can be detected at an early stage by the central control unit. The road users can then be sent accordingly in an efficient manner to an alternative route. It is thereby possible, taking account of the totality of the information on the traffic area, to define the fastest and/or shortest and/or safest route for each road user individually. A situation in which, for example, all road users take the same alternative route around an obstacle and/or a tailback, then resulting in traffic obstructions on the alternative route, can thereby be avoided. A traffic flow on the traffic area can thus be improved and a journey time of the individual road users can be reduced.

It is also possible for the central control unit to forcibly take over the control of the road user in certain, previously defined situations, for example if there is imminent danger of an accident or if a road is blocked. Possible scenarios for a blocked road are, for example, an accident and/or a regulation governing emission levels, for example air pollution control, and/or a disaster such as, for example, a gas leak.

The sensor unit of the road user advantageously acquires information from the environment of the road user even if the latter is controlled by the central control unit. The control unit of the road user can take over the control of the road user if necessary, despite the central control of the road user by the central control unit. This can occur, for example, if a dangerous situation arises for the road user and/or a further road user. In the case where, for example, a pedestrian walks into the road, or if the road user's own partially or fully autonomously driven vehicle meets a synchronously-driving convoy (platoon) of trucks or has to overtake or merge with them, the local control unit of the road user can initiate a braking procedure and/or an acceleration procedure and/or an evasive maneuver, even if a direction of travel and/or speed is specified by the central control unit. In other words, a higher-level command can be transferred by the central control unit to the control unit of the road user which the control unit of the road user follows, but can nevertheless additionally move partially or fully autonomously.

If the central control unit takes over the control of the road user, one of the following higher-level commands, for example, can be transmitted to the control unit of the road user which can then be implemented by the control unit. Driving around a specific area, for example, maintaining an average speed or a location-dependent and/or time-dependent speed, a driving behavior such as braking, accelerating, changing lanes, forming a convoy (platooning), maintaining a specific distance, for example from another vehicle and/or the road edge, activating a light function and/or signal function, driving to a specific destination, for example a gas station or electric gas station if the battery falls below a specific charge level or state of charge, or stopping or parking the vehicle or switching off the engine, for example in the event of lengthy waiting times in front of an obstacle, for example a railroad crossing, inter alia, are possible.

If a higher-level command from the central control unit cannot be implemented by the control unit of the road user, for example because a highly dangerous situation has arisen for the road user or for a further road user, this can be reported to the central control unit, whereupon the latter can calculate at least one new command and passes this on to the control unit of the road user.

In other words, a road user can be controlled in two ways. The central control unit transmits a command or higher-level command to the control unit of the road user. The latter can, however, continue to move partially or fully autonomously. The road user cannot therefore hand over control completely, but can only follow the higher-level commands from the central control unit. However, it is also possible for the central control unit to take over the complete control of the road user. This means that the central control unit can access the control of the road user directly. The control unit of the road user can then only follow the commands from the central control unit. It is furthermore possible for the control unit of the road user to evaluate information from the sensor unit of the road user and provide it to the central control unit, whereby a driving behavior can be further improved. This may e.g. be provided if road users which are not controlled by the central control unit, for example non-autonomous vehicles or pedestrians, are located on the traffic area.

If the road user again leaves the controlled traffic area, the central control unit can return the control of the road user to the control unit of the road user. A safe movement of the road user in uncontrolled traffic areas and/or the transfer from a traffic area controlled by a central control unit into an uncontrolled traffic area is/are thereby enabled. In addition, a person, for example a driver of a partially autonomous vehicle, can be informed of the transfer of control.

If a traffic area controlled by a further central control unit adjoins the first traffic area, the first central control unit of the first traffic area can transfer the control of the road user to the further central control unit of the further central traffic area. The road user can then advantageously continue to be externally controlled. In the case of partially autonomous vehicles, it is possible for a person, for example the driver, to be informed that the control of the vehicle has been taken over by a further control unit. The first control unit can inform the further control unit at an early stage that the road user is moving from the first into the further traffic area in order to guarantee an error-free transfer of the control of the road user. This may be provided, for example, if a vehicle crosses national borders and the legal regulations for partially or fully autonomous driving change, thus requiring a different, independent, central control.

If an area which is not monitored by a central control unit is located between the first traffic area and the further traffic area, control can be transferred to the control unit of the road user and the further control unit can be informed by the first control unit that a road user has left the first traffic area and plans to drive into the traffic area controlled by the further control unit. In other words, forward planning can take place.

The control unit of the road user and/or the central control unit of the traffic area on which the road user is moving can advantageously provide the next or some or all respective central control units which are located on a calculated route of the road user with information relating to the destination and a calculated estimated time of arrival of the road user in the respective traffic area. A fast, safe and efficient traffic flow can be achieved as a result.

A method with the system according to at least one of the above-mentioned aspects is furthermore provided according to various embodiments. The method can be provided to implement one or more of the provided aspects for the traffic system.

The road user may be an autonomous or partially autonomous vehicle. The vehicle may be an aircraft or a marine vehicle or a land-based vehicle. The land-based vehicle may be a motor vehicle or a rail vehicle or a bicycle. The vehicle may be a truck or a passenger vehicle or a motorcycle.

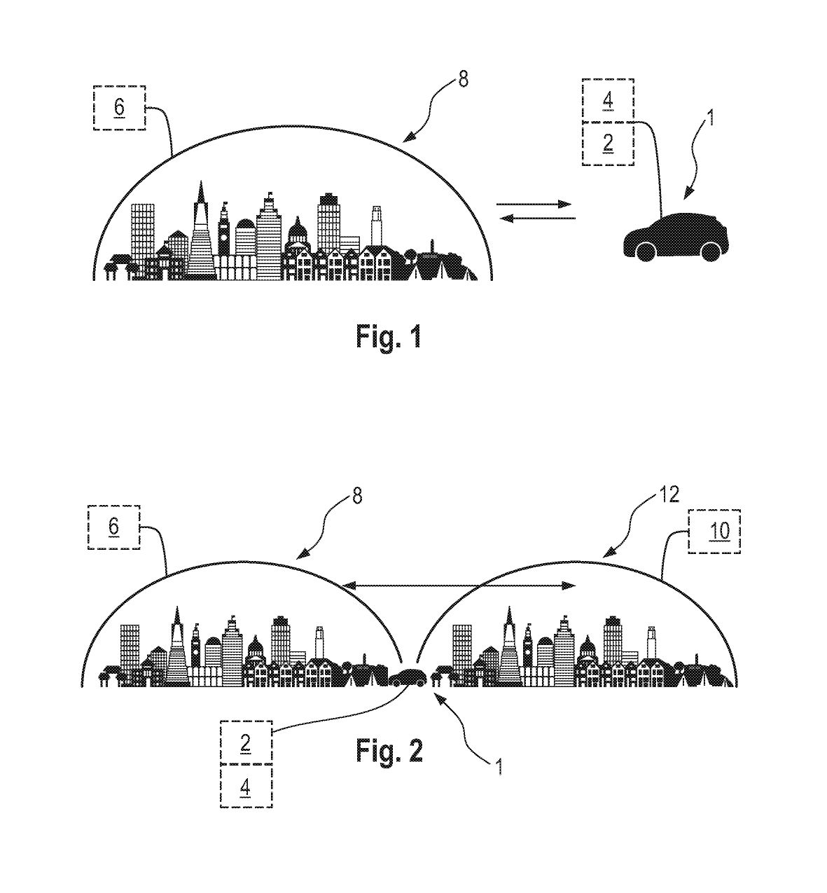

FIG. 1 shows a road user 1 which has a control unit 2 and a communication unit 4. These are shown schematically as blocks with broken lines. The road user 1 can be configured as an autonomous or partially autonomous vehicle. A central control unit 6 monitors a traffic area 8, for example a town or an urban area. If the road user 1 approaches the traffic area 8, it can communicate via its control unit 2 and its communication unit 4 with the central control unit 6 of the traffic area 8. The central control unit 6 of the traffic area 8 can, for example, register with the road user 1 and inform it that an external takeover of the control of the road user 1 by the central control unit 6 in the traffic area 8 is possible.

If the road user 1 then enters the controlled traffic area 8, the central control unit 6 can take over the control of the road user 1 completely or partially in order, for example, to make a wide detour around a tailback.

FIG. 2 shows a system with the road user 1 which again has the control unit 2 and the communication device 4, the central control unit 6 which monitors the traffic area 8 and a further control unit 10 which monitors a traffic area 12. If the road user 1 then leaves the controlled traffic area 8 in the direction of the traffic area 12, the further control unit 10 can inform the control unit 6 that the road user 1 has crossed the boundary between the traffic areas 8 and 12 and has transferred the control of the road user 1 to the control unit 10.

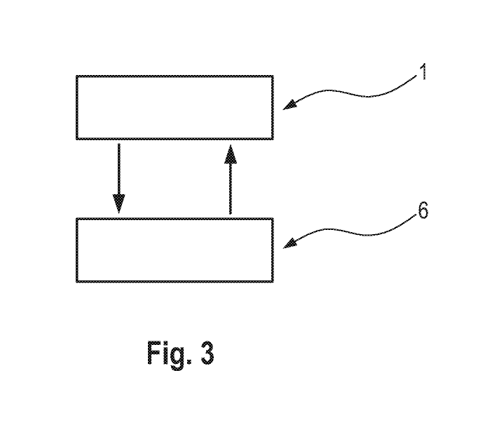

FIG. 3 shows a method with the schematic representations of the road user 1 and the central control unit 6. The road user 1 makes contact therein with the central control unit 6, for example in order to forward information which it has acquired with its own sensors. Conversely, the central control unit 6 makes contact with the road user 1 in order to signal to it that a takeover of the control of the road user 1 by the central control 6 is possible in the traffic area controlled by it. In the event of a takeover of control, the information required for this purpose is communicated.

A road user is disclosed whose control by its control unit is transferable to an external control unit, and also a traffic system with a limited traffic area, wherein an external control unit is provided which fully or partially controls the road user on the traffic area.

### LIST OF REFERENCE SIGNS

| | |
|---|---|
| Road user | 1 |
| Control unit | 2, 6, 10 |
| Communication device | 4 |
| Traffic area | 8, 12 |

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A road user, comprising:
a sensor with which information is acquirable for the road user from its environment; and
a communication circuit by means of which the information is at least one of transmittable or receivable; and
a controller which has a processor by means of which the information can be evaluated, and a control apparatus by means of which the road user is fully or partially autonomously controllable depending on the information at least one of acquired by the sensor or received by the communication circuit;
wherein a control of the road user by its controller is transferable to a central controller on the basis of at least one previously defined criterion.

2. A traffic system, comprising:
an at least one of locally limited or time-limited traffic area for at least one or more partially or fully autonomously road users, the road user comprising:
a sensor with which information is acquirable for the road user from its environment; and
a communication circuit by means of which the information is at least one of transmittable or receivable; and
a controller which has a processor by means of which the information can be evaluated, and a control apparatus by means of which the road user is fully or partially autonomously controllable depending on the information at least one of acquired by the sensor or received by the communication circuit;
wherein a control of the road user by its controller is transferable to a central controller on the basis of at least one previously defined criterion;
at least the central controller configured in such a way that a control of the at least one road user on the traffic area can be fully or partially taken over with said central controller on the basis of the at least one criterion.

3. The traffic system of claim 2,
wherein, prior to a takeover of the control of the road user, the central controller is configured to identify itself to the controller of the road user.

4. The traffic system of claim 2,
wherein the at least one criterion for a takeover of the control of the road user provided by the central controller is preset in the controller of the road user.

5. The traffic system of claim 2,
wherein the at least one criterion for a takeover of the control of the road user provided by the central controller is at least one of definable by a person or is the release by a person.

6. The traffic system of claim 2,
wherein the central controller is configured in such a way that it transmits a takeover request to the controller of the road user prior to a takeover of the control of the road user;
wherein the controller of the road user is configured to make a decision regarding the takeover request on the basis of at least one of the at least one criterion or at least one further criterion.

7. The traffic system of claim 2,
wherein the control by the central controller is provided in such a way that a higher-level command is transferred to the controller of the road user;
wherein the controller is configured to follow this higher-level command and additionally moves partially or fully autonomously.

8. The traffic system of claim 2,
wherein the central controller is configured to transmit one of the following commands to the controller of the road user:
make a detour around a specific area, and/or
adopt a driving behavior, and/or
maintain an average speed, and/or
maintain a location-dependent and/or time-dependent speed, and/or
maintain at least one specific distance, and/or
activate a light function, and/or
activate a signal function, and/or
park the road user or switch off an engine, and/or
drive to a specific destination.

9. The traffic system of claim 2,
wherein the central controller is configured to return the control of the road user to the controller of the road user as soon as the road user leaves the traffic area.

10. The traffic system of claim 2, further comprising:
the first traffic area and at least one further traffic area;
wherein each traffic area in each case has at least one central controller; and
wherein the central controller of the first traffic area is configured to transfer the control of the road user to the second controller of the further traffic area if the first and the further traffic area are adjacent to one another and the road user moves from the first traffic area into the further traffic area.

11. The traffic system of claim 2, further comprising:
a first traffic area and at least one further traffic area;
wherein each traffic area in each case has at least one central controller; and
wherein the central controller of the first traffic area is configured to inform the central controller of at least one of the further traffic area or further traffic areas of the arrival of a road user if the road user leaves the first traffic area and the respective areas are distanced from one another.

12. A method with a traffic system,
the traffic system comprising:
an at least one of locally limited or time-limited traffic area for at least one or more partially or fully autonomously road users, the road user comprising:
a sensor with which information is acquirable for the road user from its environment; and
a communication circuit by means of which the information is at least one of transmittable or receivable; and
a controller which has a processor by means of which the information can be evaluated, and a control apparatus by means of which the road user is fully or partially autonomously controllable depending on the information at least one of acquired by the sensor or received by the communication circuit;
wherein a control of the road user by its controller is transferable to a central controller on the basis of at least one previously defined criterion;
the method comprising:
at least the central controller controlling the at least one road user on the traffic area in such a way that the control can be fully or partially taken over with said central controller on the basis of the at least one criterion.
